(19) United States
(12) Patent Application Publication
(10) Pub. No.: US 2022/0094010 A1
(43) Pub. Date: Mar. 24, 2022

(54) BATTERY MODULE HOUSING AND METHOD FOR POSITIONING AND FIXING A BATTERY CELL INSIDE A BATTERY MODULE HOUSING

(71) Applicant: Lisa Draexlmaier GmbH, Vilsbiburg (DE)

(72) Inventor: Guido HOFER, Weng (DE)

(73) Assignee: Lisa Draexlmaier GmbH, Vilsbiburg (DE)

(21) Appl. No.: 17/476,557

(22) Filed: Sep. 16, 2021

(30) Foreign Application Priority Data
Sep. 23, 2020 (DE) 10 2020 124 747.8

(51) Int. Cl. H01M 50/291; H01M 50/244; H01M 50/264; H01M 50/213

(52) U.S. Cl. CPC H01M 50/291; H01M 50/213; H01M 50/264; H01M 50/244

(57) ABSTRACT

A battery module housing includes a receptacle and a positioning element. The receptacle is configured to receive a contact element. The contact element is configured to electrically contact at least one battery cell. The positioning element is disposed on the receptacle and configured to position the battery cell relative to the receptacle and the contact element so as to position and fix the battery cell relative to the contact element.

### CROSS-REFERENCE TO RELATED APPLICATIONS

This application claims priority to and the benefit of DE 10 2020 124 747.8, filed on Sep. 23, 2020. The disclosure of the above application is incorporated herein by reference.

### FIELD

The present disclosure relates to a battery module housing, into which a battery cell holder is insertable, which is configured to receive at least one first battery cell. Furthermore, the present disclosure relates to a method for positioning and fixing a battery cell inside a battery module housing.

### BACKGROUND

The statements in this section merely provide background information related to the present disclosure and may not constitute prior art.

A battery, in particular a vehicle battery of an electrically operated vehicle, comprises a plurality of battery modules that are connected to one another. The battery modules contain the battery cells. The battery cells can be round cells. During joining together of battery modules, the round cells with contact crowns, which are welded to further battery cells of a further battery module, are contacted in order to produce an electrical contact between the battery modules.

DE 10 2012 219 782 describes a battery module, in particular for use in a vehicle. The battery module comprises an in particular box-shaped battery module housing, which receives a number of battery cells, and includes a first side wall and a second side wall and a first end wall and a second end wall. The first and second end walls connect the first and second side walls at their opposing ends, and the battery module is configured such that it is stackable one-over-the-other with an identical battery module. The end walls of the upper battery module abut against the end walls of the lower battery module, and/or the first end wall and the second end wall each include at least one upper footprint and each include at least one lower footprint. The distance between the upper footprint and the lower footprint of the respective end wall is greater than the height of the section of the battery module housing disposed between the first end wall and the second end wall.

During contact of a battery cell with a contact crown, the battery cell may not be aligned precisely enough to the contact crown due to tolerances, and the contact crown may be compromised (e.g., damaged) during inserting the battery cell into the contact crown. Here the contact tabs of the contact crowns can be compromised by inaccurate alignment of the battery cell to the contact crown.

### SUMMARY

This section provides a general summary of the disclosure and is not a comprehensive disclosure of its full scope or all of its features.

The present disclosure provides a battery module housing to facilitate a precise joining together of battery cells relative to a contact element, using the most constructively simple means possible.

In one form, the present disclosure provides a battery module housing comprising a receptacle that is configured to receive a contact element. The contact element is configured to electrically contact at least one battery cell, and a positioning element that is disposed on the receptacle and configured to position the battery cell relative to the receptacle and the contact element so as to make possible a positioning and fixing of the at least one battery cell relative to the contact element.

In another form, the battery cell is preferably round cells. The receptacle can be made, for example, of plastic and is configured to receive the contact element. For example, the receptacle can be manufactured by an injection-molding method. The battery cell can be disposed, for example, in a further battery module housing.

In yet another form, on the receptacle, a positioning element is disposed that positions the battery cell of the further battery module housing with respect to the receptacle. This facilitates the inserting of the battery cell into the contact element, and a precise contacting of the battery cell with the contact element. The contact element can comprise, for example, contact tabs, which are bent away into the contact element during inserting of the battery cell, and an outer surface that contacts the battery cell so that an electrical contact is produced. The battery cell is fixed in the contact element. The positioning element includes at least one projection toward the receptacle so that the battery cell is exactly positioned with respect to the receptacle even before the contacting of the contact tabs. Here the height of the projection can be determined by the height of the contact tabs of the contact crowns. An unwanted compressing of the contact tabs by the battery cell is thus inhibited.

In one form, the positioning element comprises a plurality of partial elements, such as, for example, centering cones, which are preferably disposed on the receptacle in an edge region of a recess for the contact element. The contact surfaces of the partial elements can be adapted to the outer shape of the battery cell, so that the battery cell abuts against the partial elements of the positioning element with the greatest possible area. A plurality of positioning elements can be disposed on the receptacle in order to position a plurality of battery cells with respect to the receptacle.

In another form, a position of the contact element is determinable by a further battery cell, which is insertable in the battery module housing and is contactable by the contact element.

In yet another form, the contact element is placed, for example, on the receptacle as the contact crown, and welded to the further battery cell on its plus or minus pole in a contact region. The battery module housing can include a battery cell holder for the further battery cell. The battery cell holder can be made, for example, of a foamed material or manufactured by an injection-molding method.

In one form, the positioning element is configured as three centering cones, and the centering cones are disposed on the receptacle in a triangle. The three centering cones together form the positioning element. The centering cones each have a conical base body and are disposed on the receptacle such that the centering cones form a triangle with their center points. The battery cell is thereby positioned precisely with respect to the receptacle without the battery cell being able to slip during the positioning.

In another form, the positioning element is configured as six centering cones, and the centering cones are disposed on the receptacle in a hexagon. Using six centering cones, a more precise aligning of the battery cell with respect to the receptacle can be achieved.

In one exemplary form, the battery module housing comprises a plurality of positioning elements. At least two adjacent positioning elements share one of the centering cones. A space- and installation-space-saving arrangement of the plurality of battery cells can thereby be made possible. For example, the plurality of battery cells can thereby be disposed in the battery module housing in an offset arrangement.

In another exemplary form, the positioning element comprises an inserting chamfer which is configured to facilitate an inserting of the battery cell into the positioning element. The battery cell can be guided more exactly by the inserting chamfer during the inserting of the battery cell into the positioning element. In addition, during the insertion of the battery cell, the battery cell is protected by the inserting chamfer from damage, which can arise during the contacting of the battery cell with the positioning element.

In one form, the positioning element comprises flattened edges as contact surfaces of the positioning element to the battery cell. Due to the flattened edges as contact surfaces, the battery cell is better held between the partial elements of the positioning element.

In another form, the positioning element can be configured as a frame that can be disposed on the contact element. For example, the frame can be disposed on the contact element and connected to the battery module housing on the frame edges, for example, via a clip connection. The frame comprises a recess in a region wherein the battery cell is positioned. The recess has the same size as the battery cell. The frame has a certain thickness, so that movement tolerances of the battery cell can be compensated for during insertion into the contact element.

In yet another form, the present disclosure provides a battery module including a battery module housing comprising a receptacle into which a contact element is received. The contact element electrically contacts at least one battery cell, and a positioning element that is disposed on the receptacle and positions the battery cell relative to the receptacle and the contact element so as to simplify a positioning and fixing of the battery cell relative to the contact element.

In one form, the present disclosure provides an arrangement of a plurality of battery modules. The battery modules are joined together. The joined-together battery modules can be inserted into a battery, in particular for a vehicle battery of an electrically operated vehicle. For example, in a first battery module, a first battery cell is received in the battery cell holder of the first battery module. In the receptacle of the first battery module, a contact element is received that produces an electrical contact between the first battery cell of the first battery module and a second battery cell of a second battery module. The second battery cell is positioned with respect to the receptacle by the positioning element. The positioning element is disposed on the receptacle of the first battery module. For example, the second battery module can additionally be joined together with a third battery module. Here a third battery cell can be positioned with respect to a receptacle of the second battery module by a positioning element of the second battery module. A contact element of the second battery module can produce an electrical contact between the first battery cell and the third battery cell. Any number of battery modules can be joined together.

In another form, the present disclosure provides a method for positioning and fixing a battery cell inside a battery module housing comprising a receptacle that is configured to receive a contact element. The contact element is configured to electrically contact at least one battery cell, and a positioning element that is disposed on the receptacle and configured to position the battery cell relative to the receptacle and the contact element so as to make possible a positioning and fixing of the at least one battery cell relative to the contact element.

In yet another form, inserting the battery cell into the receptacle and disposing the positioning element on the receptacle is performed so that the battery cell is positioned and fixed relative to the contact element.

In one form, the positioning and fixing of the plurality of battery cells inside different battery modules can be performed automatically, and subsequently the respective battery modules can be joined together, in an automated process.

In another form, the joined battery modules can be inserted, for example, in a housing of a battery or of a high-voltage storage device, in particular a vehicle battery of an electrically operated vehicle.

In yet another form, it is provided that the positioning element is configured as three centering cones, and the centering cones are disposed in a triangle on the receptacle and thus relative to the battery cell such that during disposing of the centering cones relative to the receptacle and thus to the contact element, it is positioned and fixed on the battery cell.

In one form, the positioning element comprises an insertion chamfer, and thus an inserting of the at least one battery cell into the positioning element is facilitated.

Further features, advantages, and details of the present disclosure arise from the following description of an exemplary form as well as with reference to the drawings. The features and feature combinations mentioned above in the description, as well as the features and feature combinations shown below in the Figure description and/or in the Figures alone are usable not only in the combination specified, but also in other combinations or alone without departing from the context of the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is an exploded view of a battery module according to the present disclosure;

FIG. 2 is a plan view of a receptacle of the battery module of FIG. 1;

FIG. 3 is a plan view of the battery module of FIG. 1;

FIG. 4 is a cross-sectional view of a portion of the battery module of FIG. 1;

FIG. 5 is a plan view of a positioning element of the battery module of FIG. 1;

FIG. 6 is a side view of the positioning element of the battery module; and

FIG. 7 is a schematic representation of an exemplary method for positioning and fixing a battery cell inside a battery module housing.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

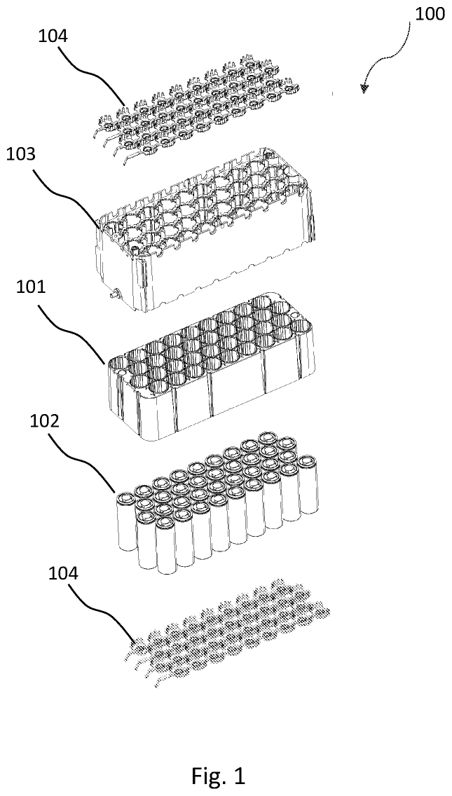

FIG. 1 shows an exploded view of a battery module 100 according to an exemplary form. The battery module 100 comprises a plurality of battery cells 102. The battery cells 102 are inserted in a battery cell holder 101. The battery cell holder 101 can be manufactured, for example, from a foamed material. The battery cell holder 101 is disposed with the battery cells 102 in a receptacle 103. The receptacle 103 comprises recesses for the battery cells 102 and can be manufactured, for example, by an injection-molding method. A first positioning element 105 and a second positioning element 106 are disposed on the recesses. The positioning elements 105, 106 comprise centering cones 107a, 107b, 107c, 108a, 108b, 108c which, according to the exemplary form, are each disposed in a triangle, each around one recess for a battery cell 102. Contact crowns 104 are welded as contact elements on the inserted battery cells 102, which contact crowns 104 produce an electrical contact between the inserted battery cells 102 and further or second battery cells of a further or second battery module when the battery module 100 is joined together with the further battery module. In a joined state of the battery modules 100, the further battery cells are inserted into contact crowns 104 on the side of the contact crowns 104 opposing the side welded to the battery cells 102.

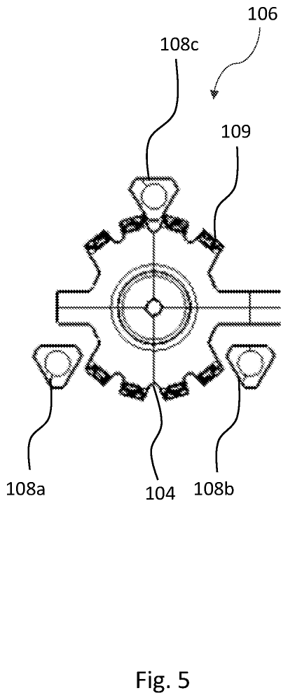

According to the exemplary form, with additional reference to FIG. 5, each of the contact crowns 104 comprise eight contact tabs 109, which are resilient and are bent into the contact crowns 104 during inserting of the further battery cells and contact an outer surface of the respective further battery cells in order to thus produce both a fixing of the further battery cells and an electrical contact between the battery cells 102 and the further battery cells. During the inserting of the further battery cells into the contact crowns 104, the positioning elements 105, 106 including their centering cones 107a, 107b, 107c, 108a, 108b, 108c precisely position the further battery cells with respect to the receptacle 103, so that the inserting is facilitated, and the contact tabs 109 are not compromised by the further battery cells during the inserting. For example, the battery module 100 can comprise a cooling component for cooling the battery cells 102, for example, a cooling plate. Furthermore, further electronic components can be disposed on the battery module 100.

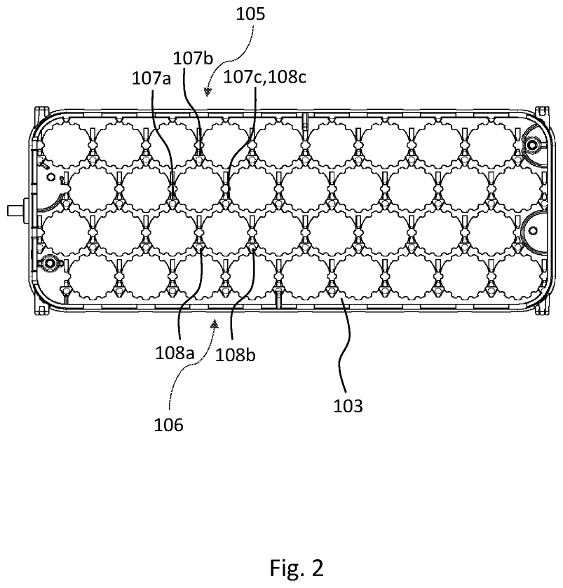

FIG. 2 shows the positioning elements 105, 106 within the receptacle 103 of the battery module 100. The positioning elements 105, 106 protrude beyond the receptacle 103 in an insertion direction of the further battery cells, so that during inserting of the further battery cells into the contact crowns 104, the further battery cells are already precisely positioned with respect to the receptacle 103 before contacting the contact tabs 109. The centering cones 107a, 107b, 107c, 108a, 108b, 108c can be disposed, for example, in a hexagon around the recesses. Each of the centering cones 107a, 107b, 107c, 108a, 108b, 108c comprises an insertion chamfer, whereby inserting the further battery cells into the contact crowns 104 is facilitated. According to the exemplary form, two positioning elements 105, 106 share a centering cone 107c, 108c. Due to the arrangement of the positioning elements 105, 106, the first battery cell 102 and the further battery cell can be staggered and thus disposed in the battery module 100 in a space-saving manner.

Furthermore, the receptacle 103 can include notches between the recesses. Corresponding thereto the contact crowns 104 can be connected to one another via bridges. In order to arrange the contact crowns 104 precisely on the battery cells 102, the bridges of the contact crowns 104 are inserted into the notches of the receptacle 103 when the contact crowns 104 are disposed on the receptacle 103.

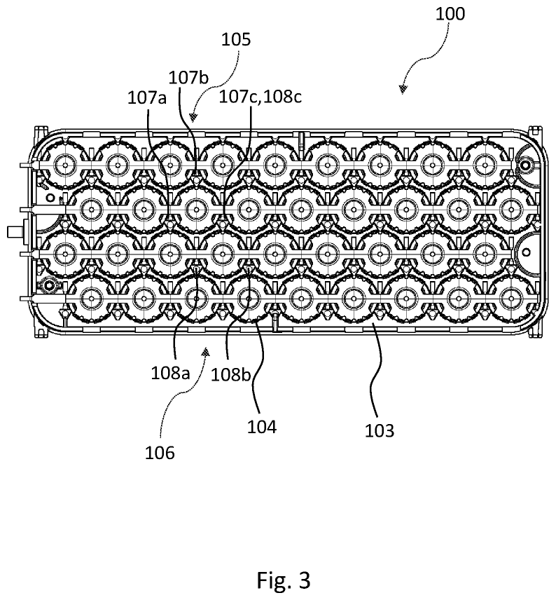

FIG. 3 shows the battery module 100 whereby the battery cells 102 are inserted in the receptacle 103 and the contact crowns 104 are welded to the battery cells 102. According to FIG. 3, it can be seen that the contact crowns 104 are disposed centrally with respect to the battery cells 102. Any number of battery cells 102 can be disposed in the battery module 100.

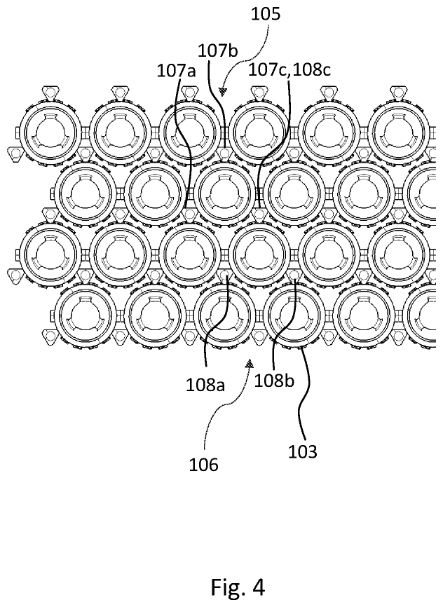

FIG. 4 shows a cross-section of the battery module 100 whereby the battery cells 102 are inserted in the battery module 100. In another variation, no battery cells 102 are inserted. The contact surfaces of the centering cones 107a, 107b, 107c, 108a, 108b, 108c with the further battery cells are flattened. The further battery cells can thereby be held better between the centering cones 107a, 107b, 107c, 108a, 108b, 108c during the positioning with respect to the receptacle 103 and the inserting into the contact crowns 104.

FIG. 5 shows a plan view of the positioning element 106. In this figure, the contact crown 104 is disposed off-center with respect to the receptacle 103. In another form, the contact crowns 104 are aligned centered with respect to the receptacle 103. The flattened edges of the centering cones 108a, 108b, 108c can be seen from FIG. 5. The contact tabs 109 of the contact crown 104 are not damaged by the centering cones 108a, 108b, 108c of the further battery cells during the inserting of the further battery cell into the contact element 104.

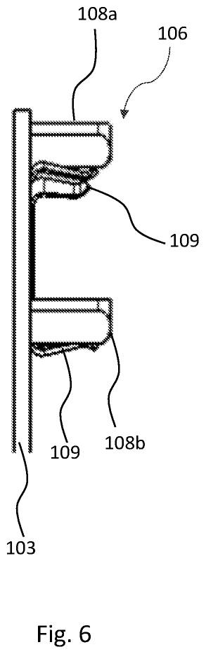

FIG. 6 shows a side view of the positioning element 106. The positioning element 106 protrudes beyond the receptacle 103. The height of the positioning element 106 is determined by the height of the contact tabs 109. According to FIG. 6, the positioning element 106 is higher than the contact tabs 109. The positioning element 106 may include a height that is at least equal to a height of the contact tabs 109 to inhibit damage of the contact tabs 109.

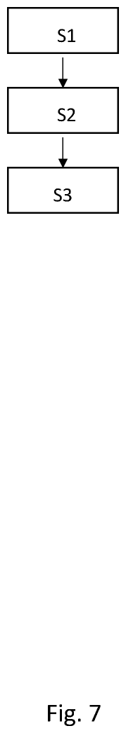

FIG. 7 shows a schematic representation of an exemplary method for positioning and fixing a battery cell inside a battery module housing.

In a first step S1, a first battery module 100 is provided. First battery cells 102 can be inserted in the first battery module 100. The first battery cells 102 can be held in the first battery module 100 by the battery cell holder 101, which is preferably manufactured from foamed material. The contact crowns 104 can be welded on as contact elements onto the battery cells 102.

In a second step S2, a second battery module is provided. Second battery cells are inserted in the second battery module, which second battery cells are positioned with respect to the receptacle 103 and with respect to the contact element 104, during the joining of the first battery module 100 with the second battery module, in order to facilitate the inserting of the second battery cells into the contact element 104.

In a third step S3, the first battery module 100 and the second battery module are joined by the second battery module being attached to the first battery module 100. That is, the second battery cells of the second battery module are positioned with respect to the receptacle 103 of the first battery module 100 by positioning elements 105, 106. The second battery cells are positioned by the positioning elements 105, 106 so as to facilitate inserting of the second battery cells into the contact crowns 104. Here, the contact tabs 109 of the contact crowns 104 contact the outer surfaces of the respective second battery cells and thus fix the second battery cells in the contact element 104. An electrical contact arises between the first battery module 100 and the second battery module when second battery cells are also inserted in the first battery module 100.

The joining together of the first battery module 100 and the second battery module can be achieved, for example, automatically in a production process. Due to the aspects of the present disclosure, the joining of the first battery module 100 and the second battery module can be facilitated. In particular, the contact element is not damaged by the positioning elements 105, 106 during the inserting of the second battery cells into the contact element. In addition, the second battery cells can be disposed in the battery module 100 in a space-saving manner.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery module housing comprising:
a receptacle configured to receive a contact element that is adapted to electrically contact at least one battery cell; and
a positioning element disposed on the receptacle and configured to position the at least one battery cell relative to the receptacle and the contact element so as to fix the at least one battery cell relative to the contact element.

2. The battery module housing according to claim 1, wherein a position of the contact element is prescribable by a further battery cell, which is insertable in the battery module housing and contactable with the contact element.

3. The battery module housing according to claim 1, wherein the positioning element is configured as three centering cones and the centering cones are disposed on the receptacle in a triangle.

4. The battery module housing according to claim 1, wherein the positioning element is configured as six centering cones, and the centering cones are disposed on the receptacle in a hexagon.

5. The battery module housing according to claim 4, further comprising a plurality of positioning elements, and wherein at least two adjacent positioning elements share one of the centering cones.

6. The battery module housing according to claim 1, wherein the positioning element comprises an insertion chamfer configured to facilitate insertion of the at least one battery cell into the positioning element.

7. The battery module housing according to claim 1, wherein the positioning element comprises flattened edges as contact surfaces of the positioning element with respect to the at least one battery cell.

8. A method for positioning and fixing at least one battery cell inside a battery module housing, the method comprising:
providing a battery module housing comprising a receptacle configured to receive a contact element, the contact element configured to electrically contact the at least one battery cell;
disposing a positioning element on the receptacle, the positioning element configured to position the at least one battery cell relative to the receptacle and the contact element so as to fix the at least one battery cell relative to the contact element; and
inserting the at least one battery cell into the receptacle, so that the at least one battery cell is positioned and fixed relative to the contact element.

9. The method according to claim 8, wherein the positioning element is configured as three centering cones and the centering cones are disposed on the receptacle in a triangle such that during disposing of the centering cones relative to the receptacle and the contact element the centering cones are positioned and fixed on the at least one battery cell.

10. The method according to claim 8, wherein the positioning element comprises an insertion chamfer to facilitate insertion of the at least one battery cell into the receptacle.
